(19) United States
(12) Patent Application Publication
(10) Pub. No.: US 2023/0097558 A1
(43) Pub. Date: Mar. 30, 2023

(54) Order an Advertised Subject from a Third Party Shopping System

(71) Applicant: Roku, Inc, San Jose, CA (US)

(72) Inventors: Shravan MAJITHIA, San Jose, CA (US); Michael Veach, San Jose, CA (US); Derrick Johnson, San Jose, CA (US); Akshay Jain, San Jose, CA (US); Vinay Muthreja Ashok, San Jose, CA (US); Shyam Srinivas, San Jose, CA (US)

(73) Assignee: Roku, Inc, San Jose, CA (US)

(21) Appl. No.: 17/488,929

(22) Filed: Sep. 29, 2021

(51) Int. Cl. H04N 21/478; H04L 29/08; H04N 21/45; H04N 21/81; H04N 21/422; G06Q 30/06

(52) U.S. Cl. CPC H04N 21/47815; H04L 67/20; H04N 21/4532; H04N 21/812; H04N 21/42204; G06Q 30/0613; G06Q 30/0637; G06Q 20/12

(57) ABSTRACT

Disclosed herein are system, apparatus, article of manufacture, method and/or computer program product embodiments, and/or combinations and sub-combinations thereof, for a multimedia environment that includes a computing device, a media server system, and a third party shopping system. The computing device can display an advertisement including a reference to an advertised subject provided by the third party shopping system. The computing device can further display media content provided by the media server system. In response to receiving an indication to place an order for an item associated with the advertised subject, the computing device can further collect information included in the order. The computing device can further transmit, to the third party shopping system, at least a portion of the order and media account information. The order is recorded in a user shopping account corresponding to the media account associated with the computing device.

### BACKGROUND

### Field

This disclosure is generally directed to place an order for an advertised subject from a third party shopping system, and more particularly to a control a computing device to place an order through a media system for an advertised subject provided by a third party shopping system.

### Background

One of the biggest trends shaping advertising is the rapid rise of streaming video viewership. With an estimated 150 million US adults now accessing streaming video from various streaming services, through media devices or systems, a new medium known as over-the-top (OTT) advertising has emerged, allowing brands to reach their audiences directly within their living rooms. T-Commerce is a term describing trade via a smart digital TV set, which acts as a marketing channel enabling bidirectional communication for interactive advertising and addressable advertising. However, implementing T-commerce efficiently can be a challenge for multiple reasons.

### SUMMARY

Provided herein are system, apparatus, article of manufacture, method and/or computer program product embodiments, and/or combinations and sub-combinations thereof, for controlling a computing device to place an order through a media server system for an advertised subject being advertised by the computing device and provided by a third party shopping system.

An example embodiment of a multimedia environment includes a computing device, a media server system, and a third party shopping system. The computing device can display an advertisement including a reference to an advertised subject provided by the third party shopping system. The advertisement can include one or more advertised subjects. The computing device can further display media content provided by the media server system different from the third party shopping system. The media content can be provided by the media server system according to a media account associated with the computing device managed by the media server system. In response to receiving an indication to place an order for the advertised subject, the computing device can further collect information included in the order. The information included in the order can include information about a user and information about the advertised subject. The computing device can further transmit, to the third party shopping system, at least a portion of the order and media account information. The order is recorded in a user shopping account managed by the third party shopping system, where the user shopping account corresponds to the media account associated with the computing device based on the media account information.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example multimedia environment for controlling a computing device to place an order through a media server system for an advertised subject provided by a third party shopping system, according to some embodiments.

FIGS. 4A-4G illustrate example steps of a process performed by a computing device to place an order through a media server system for an advertised subject provided by a third party shopping system, according to some embodiments.

FIG. 5 illustrates an example multimedia environment for controlling a computing device to place an order through a media server system for an advertised subject provided by a third party shopping system, according to some embodiments.

FIG. 6 illustrates an example process performed by a computing device to place an order through a media server system for an advertised subject provided by a third party shopping system, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Advertising is a marketing communication that employs an openly sponsored, non-personal message to promote or sell a product, service or idea. Advertisements can be placed in various media, e.g., displayed on a television. The sales process starts with marketing and advertising. Closing sales is a crucial aspect of any business. However, there may be a long process and delay from displaying an advertisement for a product to closing a sale for the product.

One trend shaping advertising is the rapid rise of streaming video viewership. A new medium known as over-the-top (OTT) advertising has emerged, allowing brands to reach their audiences directly within their living rooms. T-Commerce is a term describing trade via smart digital TV-set that can act as a marketing channel in addition to its main functionality of displaying media content. T-Commerce can use a media system to enable bidirectional communication, interactive advertising and addressable advertising. Efficient methods to control a computing device to place an order through a media system for an advertised subject provided by a third party shopping system is desired.

An example embodiment of a multimedia environment includes a computing device, a media server system, and a third party shopping system. The embodiments can facilitate a user to place an order for an advertised subject provided by a third party shopping system, without the user logging in to the user shopping account in the third party shopping system. The user can be identified by a user shopping account managed by the third party shopping system. The user shopping account corresponds to the media account associated with the computing device. The payment for the order can be separately handled and collected by the media account associated with the computing device. Therefore, the user can place the order much more efficiently, reducing the time and delay in converting an advertisement into a sale, hence increasing the revenue for the business.

In some embodiments, the computing device can display an advertisement including a reference to an advertised subject provided by a third party shopping system. The advertisement can include one or more advertised subjects. The computing device can further display media content provided by a media server system different from the third party shopping system. The media content can be provided by the media server system according to a media account associated with the computing device managed by the media server system. In response to receiving an indication to place an order for the advertised subject, the computing device can collect information included in the order. The information included in the order can include information about a user and information about the advertised subject. The computing device can further transmit, to the third party shopping system, at least a portion of the order and media account information. The order is recorded in a user shopping account managed by the third party shopping system, where the user shopping account corresponds to the media account associated with the computing device based on the media account information. The order can be recorded in the user shopping account without the user logging in to the user shopping account in the third party shopping system.

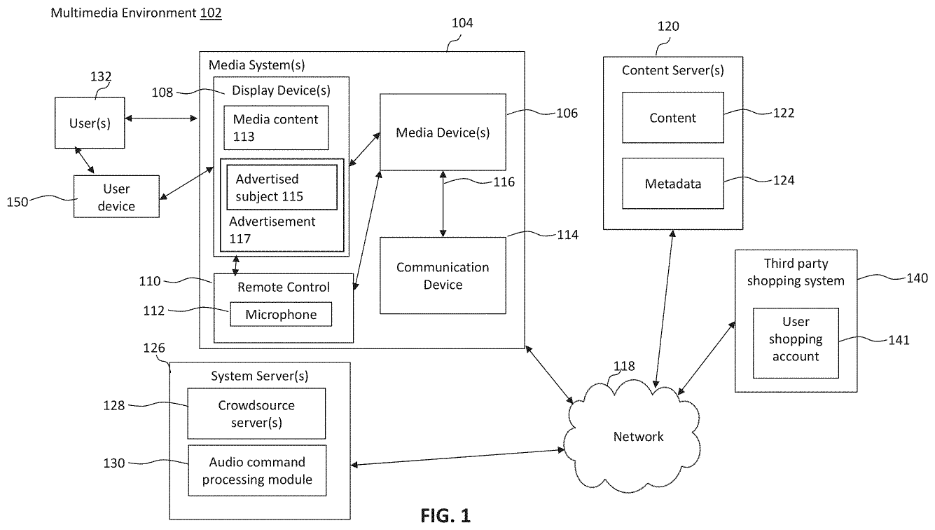

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to multimedia environment 102, as will be appreciated by persons skilled in the relevant art(s) based on the teachings contained herein. An example of multimedia environment 102 shall now be described.

Multimedia Environment

FIG. 1 illustrates a block diagram of multimedia environment 102, according to some embodiments. Multimedia environment 102 illustrates an example environment, architecture, ecosystem, etc., in which various embodiments of this disclosure may be implemented. However, multimedia environment 102 is provided solely for illustrative purposes, and is not limiting. Embodiments of this disclosure may be implemented and/or used in environments different from and/or in addition to multimedia environment 102 of FIG. 1, as will be appreciated by persons skilled in the relevant art(s) based on the teachings contained herein.

In a non-limiting example, multimedia environment 102 may be directed to streaming media. However, this disclosure is applicable to any type of media (instead of or in addition to streaming media), as well as any mechanism, means, protocol, method and/or process for distributing media.

Multimedia environment 102 may include one or more media systems 104. Media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with media system 104 to select and consume content. User 132 may interact with media system 104 through a user device 150.

Each media system 104 may include one or more media devices 106 each coupled to one or more display devices 108. Media device 106 may be referred to as a computing device as well. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, a streaming set-top box (STB), cable and satellite STB, a DVD or BLU-RAY device, an audio/video playback device, cable box, and/or a digital video recording device, to name just a few examples. Display device 108 may be a monitor, a television (TV), a computer, a computer monitor, a smart phone, a tablet, a wearable (such as a watch or glasses), an appliance, an internet of things (IoT) device, and/or a projector, to name just a few examples. In some embodiments, media device 106 can be a part of, integrated with, attached to, operatively coupled to, and/or connected to its respective display device 108. Media device 106 can provide media content 113 to display device 108. In addition, media device 106 can provide an advertisement 117 to be displayed on display device 108, where advertisement 117 can include one or more advertised subjects, e.g., an advertised subject 115.

Each media device 106 may be configured to communicate with network 118 via a communication device 114. Communication device 114 may include, for example, a cable modem or satellite TV transceiver. Media device 106 may communicate with communication device 114 over a link 116, where link 116 may include wireless (such as WiFi) and/or wired connections.

In various embodiments, network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. Remote control 110 can be any component, part, apparatus and/or method for controlling media device 106, display device 108, such as a remote control, a tablet, laptop computer, smartphone, wearable, on-screen controls, integrated control buttons, audio controls, or any combination thereof, to name just a few examples. In an embodiment, remote control 110 wirelessly communicates with media device 106, or display device 108 using cellular, Bluetooth, infrared, etc., or any combination thereof.

Multimedia environment 102 may include a plurality of content servers 120 (also called content providers or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Content 122 may be the source for media content 113 displayed on display device 108.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to content 122. Metadata 124 may also or alternatively include links to any such information pertaining or relating to content 122. Metadata 124 may also or alternatively include one or more indexes of content 122, such as but not limited to a trick mode index.

Multimedia environment 102 may include one or more system servers 126. System servers 126 may operate to support media device 106 from the cloud. It is noted that the structural and functional aspects of system servers 126 may wholly or partially exist in the same or different ones of system servers 126. System servers 126 and content server 120 together may be referred to as a media server system. An overall media system may include a media server system and media system 104. In some embodiments, a media system may refer to the overall media system including the media server system and media system 104.

Media devices 106 may exist in thousands or millions of media systems 104. Accordingly, media devices 106 may lend themselves to crowdsourcing embodiments and, thus, system servers 126 may include one or more crowdsource servers 128.

For example, using information received from media devices 106 in the thousands and millions of media systems 104, crowdsource server(s) 128 may identify similarities and overlaps between closed captioning requests issued by different users 132 watching a particular movie. Based on such information, crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, crowdsource server(s) 128 may operate to cause closed captioning to be automatically turned on and/or off during future streaming of the movie.

System servers 126 may also include an audio command processing module 130. As noted above, remote control 110 may include a microphone 112. Microphone 112 may receive audio data from user 132 (as well as other sources, such as display device 108). In some embodiments, media device 106 may be audio responsive, and the audio data may represent verbal commands from user 132 to control media device 106 as well as other components in media system 104, such as display device 108.

In some embodiments, the audio data received by microphone 112 in remote control 110 is transferred to media device 106, which is then forwarded to audio command processing module 130 in system servers 126. Audio command processing module 130 may operate to process and analyze the received audio data to recognize a verbal command from user 132. Audio command processing module 130 may then forward the verbal command back to media device 106 for processing.

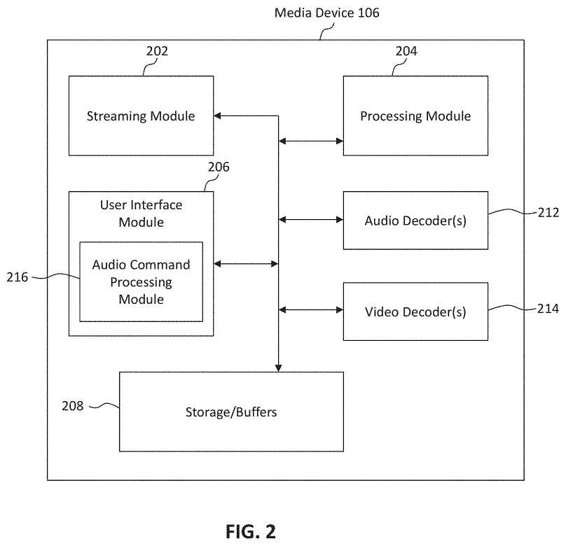

In some embodiments, the audio data may be alternatively or additionally processed and analyzed by an audio command processing module 216 in media device 106 (see FIG. 2). Media device 106 and system servers 126 may then cooperate to pick one of the verbal commands to process (either the verbal command recognized by audio command processing module 130 in system servers 126, or the verbal command recognized by audio command processing module 216 in media device 106).

In some embodiments, multimedia environment 102 may include a third party shopping system 140. Third party shopping system 140 may provide advertisement 117 including advertised subject 115 to be displayed on display device 108. Third party shopping system 140 can also receive an order from user 132, and record the order in a user shopping account 141 managed by the third party shopping system.

FIG. 2 illustrates a block diagram of an example media device 106, according to some embodiments. Media device 106 may include a streaming module 202, a processing module 204, a storage/buffers 208, and a user interface module 206. As described above, user interface module 206 may include audio command processing module 216.

Media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, user 132 may interact with media device 106 via, for example, remote control 110. User device 150 may provide additional control and communication with media device 106 or third party shopping system 140. For example, user 132 may use remote control 110 to interact with user interface module 206 of media device 106 to select content, such as a movie, TV show, music, book, application, game, etc. Streaming module 202 of media device 106 may request the selected content from content server(s) 120 over network 118. Content server(s) 120 may transmit the requested content to streaming module 202. Media device 106 may transmit the received content to display device 108 for playback to user 132.

In streaming embodiments, streaming module 202 may transmit the content to display device 108 in real time or near real time as it receives such content from content server(s) 120. In non-streaming embodiments, media device 106 may store the content received from content server(s) 120 in storage/buffers 208 for later playback on display device 108.

Coordination Between a Source Media Device, a Host Device, and a Speaker Device.

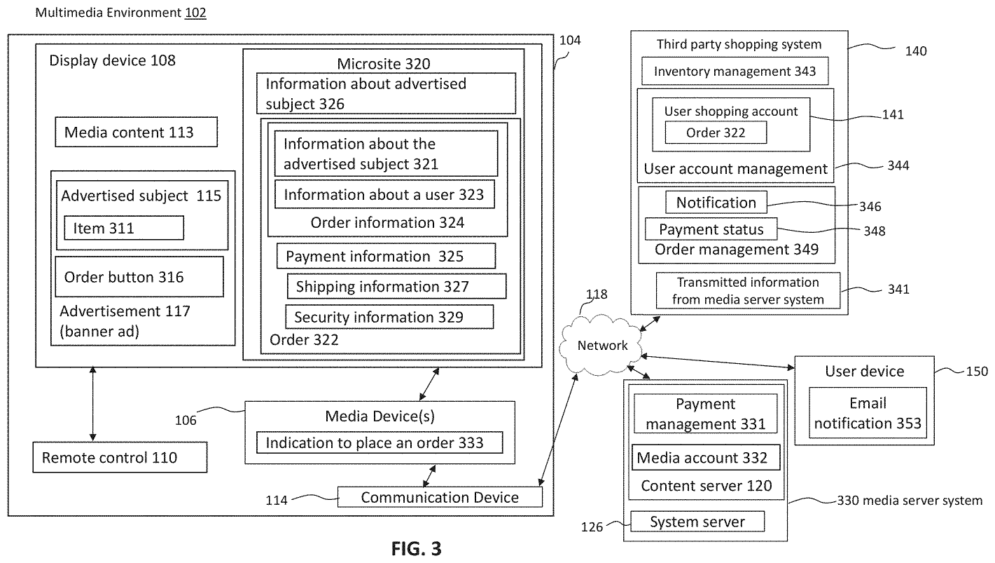

FIG. 3 illustrates more details of multimedia environment 102 for controlling a computing device, e.g., media device 106, to place an order 322 through a media server system 300 for advertised subject 115 provided by third party shopping system 140. As described in FIG. 1, multimedia environment 102 includes media systems 104 that includes media device 106, display devices 108, and remote control 110; a media server system 330 that includes content server 120 and system server 126; third party shopping system 140; and user device 150. Media device 106 may be referred to as a computing device as well. In some embodiments, media server system 330 can be a system different from third party shopping system 140. Media device 106 can be associated with a media account 332 managed by media server system 330. For example, media account 332 can be saved in content server 120, and media account 332 can uniquely identify media device 106. Media server system 330 may be communicatively coupled to multiple third party shopping systems.

In some embodiments, media device 106 can provide media content 113 to display device 108. Media content 113 can be provided to media device 106 by media server system 330, such as by content server 120. Media content 113 can be provided by media server system 330 according to media account 332 associated with media device 106 managed by media server system 330. In some embodiments, media content 113 can be provided according to subscriptions associated with media account 332.

In some embodiments, media device 106 can provide an advertisement 117 to be displayed on display device 108, where advertisement 117 can include one or more advertised subjects, e.g., advertised subject 115, which are provided by third party shopping system 140. Advertised subject 115 can include a service provided by a service provider, or an object that is sold by a merchant. Advertised subject 115 can be displayed based on a user profile or demographic information of user 132, or a user profile associated with media account 332. For example, advertised subject 115 can be selected based on media content 113 so that advertised subject 115 is related to media content 113. There may be multiple items, e.g., item 311, associated with advertised subject 115. In some embodiments, a reference to advertised subject 115 can be displayed instead of a shape or name of advertised subject 115.

In some embodiments, there can be an order button 316 displayed for advertised subject 115 so that user 132 can provide an input as an indication to place an order for advertised subject 115, such as an item associated with advertised subject 115.

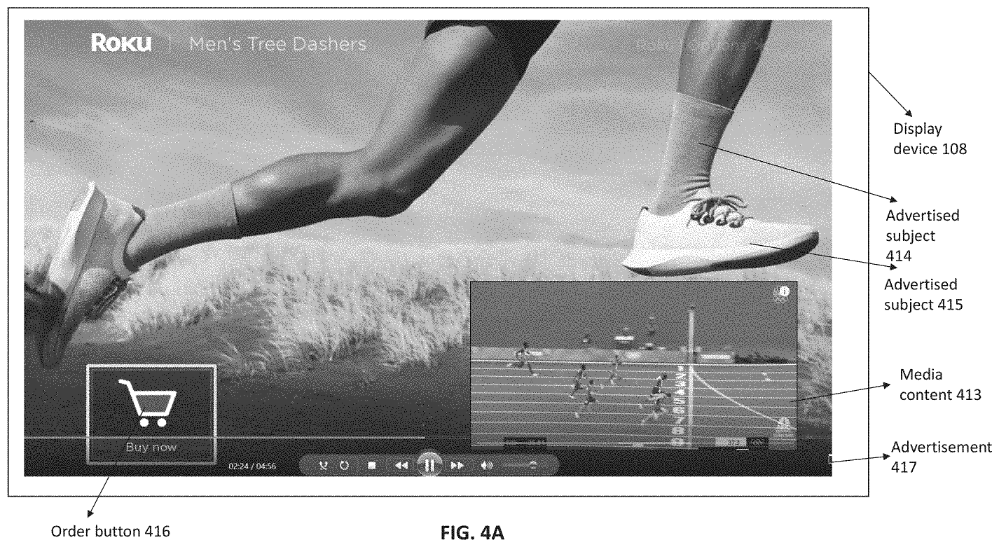

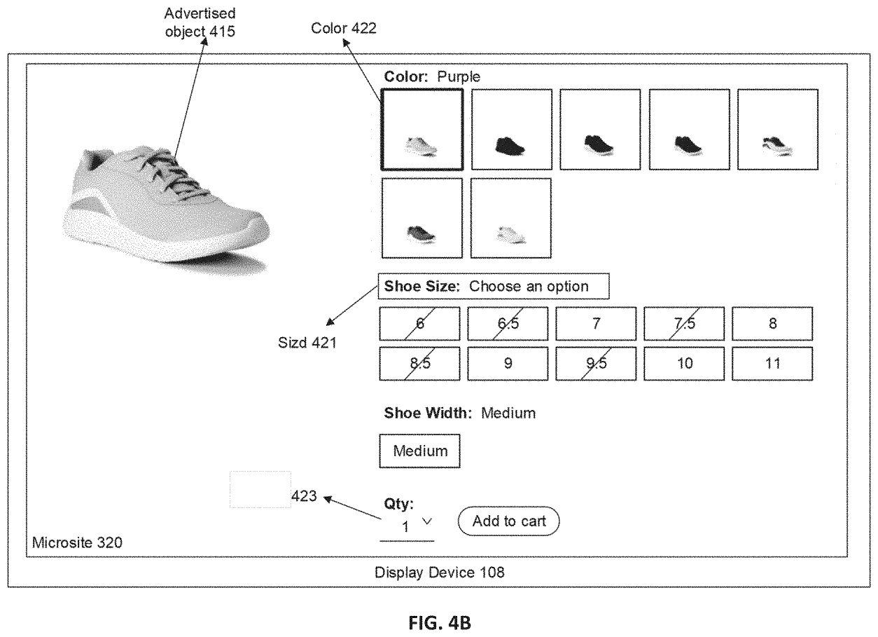

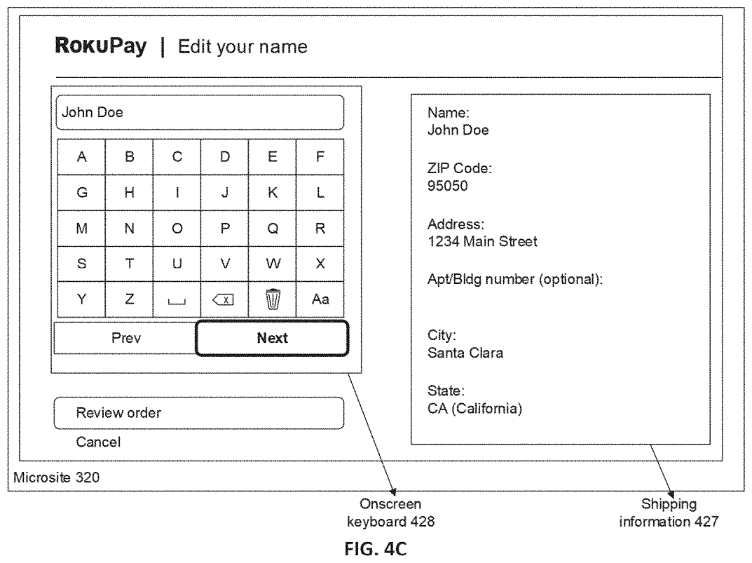

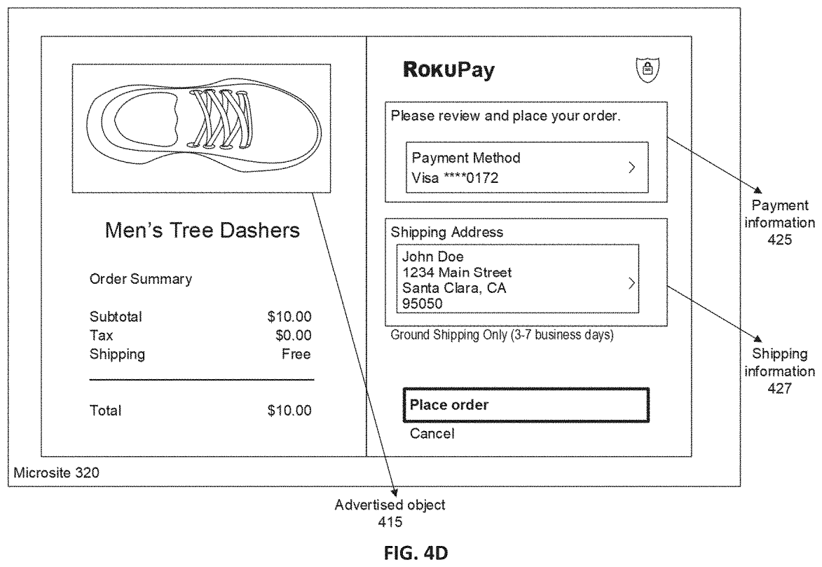

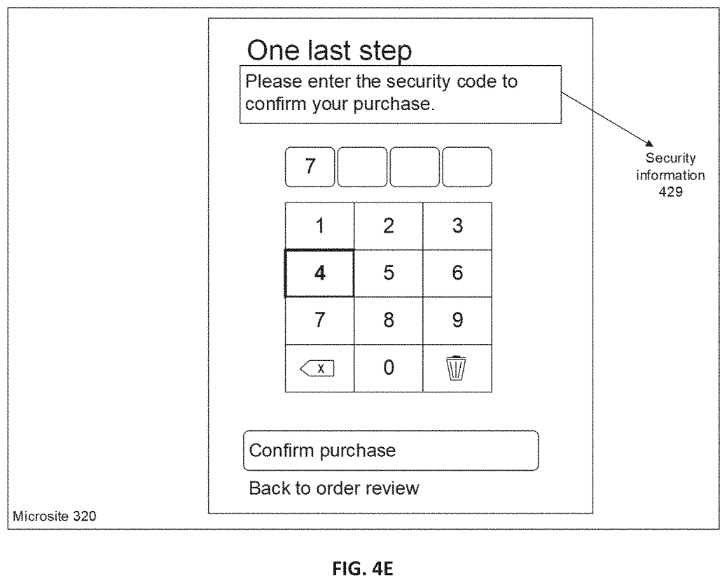

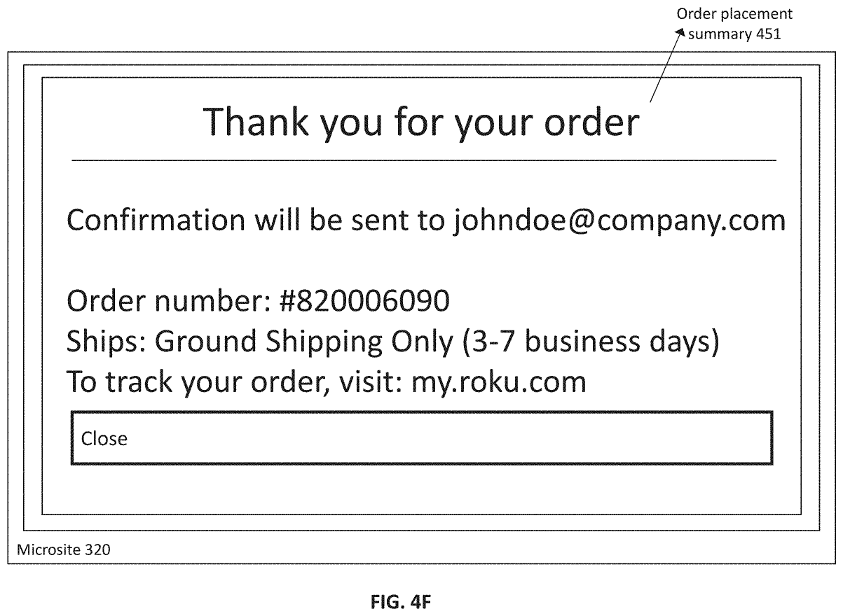

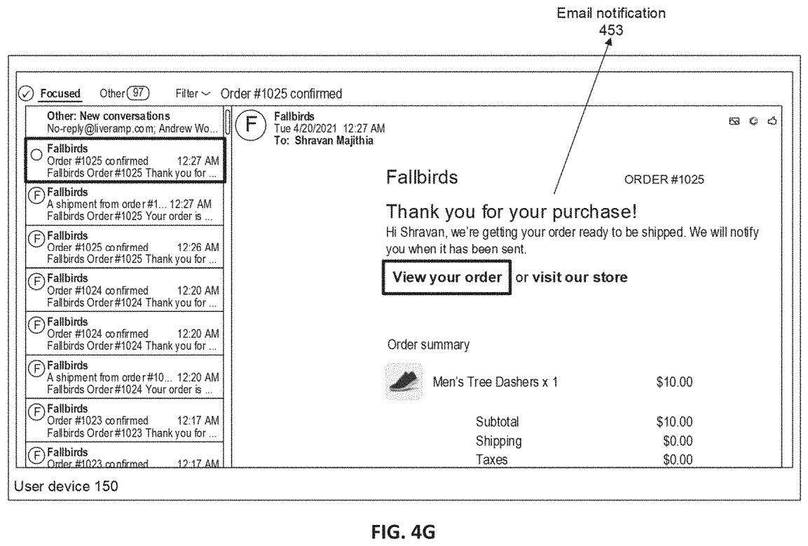

In some embodiments, as shown in FIG. 4A, an advertisement 417 is displayed on display device 108. Advertisement 417 can include an advertised subject 415 which is a shoe, and an advertised subject 414 which is a sock, and an order button 416. There can be multiple items associated with advertised subject 415 or advertised subject 414. For example, there can be multiple pairs of shoes or socks. In some embodiments, when advertised subject 415 is displayed, at least an item associated with advertised subject 415 is in stock of the inventory provided by third party shopping system 140. In some other embodiments, advertised subject 414 can be displayed regardless whether there is any item associated with advertised subject 414 is in stock of the inventory provided by third party shopping system 140.

In some embodiments, media content 413 can be displayed on display device 108. Advertisement 417 can be displayed at a same time when media content 413 is displayed. In some embodiments, advertisement 417 can be displayed following the displaying of media content 413. There may be many other ways to display media content 413, and advertisement 417, such as displayed in parallel, in sequence, or overlapped.

In some embodiments, media device 106 can provide information to be displayed on display devices 108 for user 132, and can further collection information from user 132 through various forms or other format displayed on display devices 108. A microsite 320 can be displayed by media device 106 and on display devices 108 to display information to user 132 or collect information from user 132. Microsite 320 can be provided by third party shopping system 140 through network 118 and communication device 114.

In some embodiments, user 132 can provide an indication 333 to place an order for an item associated with the advertised subject. Media device 106 can receive a user input from remote control 110 associated with media device 106 to place order 322. User 132 can point remote control 110 to advertised subject 415, advertised subject 414, or order button 416 to provide indication 333 to place an order for an item associated with the advertised subject. The indication 333 to place an order for the advertised subject can be received and saved by media device 106. Order 322 can be recorded in user shopping account 141 without the user logging in to the user shopping account in third party shopping system 140. Order 322 can be placed in microsite 320 displayed by media device 106 on display device 108.

In some embodiments, in response to receiving indication 333 to place order 322 for advertised subject 115, media device 106 can provide information 326 about advertised subject to user 123, and further collect information included in order 322. Media device 106 can display information 326 of the advertised subject for user 132 to select the item, where information 326 of advertised subject 115 can include a size of advertised subject 115, a color of advertised subject 115, a quantity of the item to be purchased, a functional feature of advertised subject 115, a sales promotion information, or any other sales or marketing related information for advertised subject 115.

In some embodiments, as shown in FIG. 4B, microsite 320 can be displayed on display device 108. Microsite 320 can display information 326 of advertised subject 415 for user 132 to select a pair of shoes. The information of advertised subject 415 includes a size 421 of the advertised subject, a color 422 of the advertised subject, a quantity of the item 423 to be purchased, among other information.

In some embodiments, through displayed information 326 about advertised subject 115 to user 123, media device 106 can collect information 324 included in an order 322. The information 324 included in order 322 can include information 323 about a user and information 321 about the advertised subject. Order 322 can further include payment information 325, shipping information 327, security information 329, among other information. In some embodiments, information 323 about the user can include shipping information 327 for the user or payment information 325 for the user. In some other embodiments, shipping information 327 or payment information 325 can be saved or preconfigured for media device 106 before order 322 is placed.

In some embodiments, as shown in FIG. 4C, shipping information 427 can be an example of shipping information 327, and can include a user name John Doe, and an address. There can be an onscreen keyboard 428 displayed as well so that user 132 can provide the input through onscreen keyboard 428.

In some embodiments, as shown in FIG. 4D, microsite 320 can display a summary of order 322, which includes shipping information 427, payment information 425, and advertised subject 415. Shipping information 427, payment information 425, and advertised subject 415 are examples of shipping information 327, payment information 325, and advertised subject 115. In some embodiments, as shown in FIG. 4E, microsite 320 can display a security information 429, which can be an example of security information 329. In some embodiments, as shown in FIG. 4F, microsite 320 can display an order placement summary 451.

In some embodiments, media device 106 can transmit, to third party shopping system 140, transmitted information 341 from media server system 330, where transmitted information 341 can include at least a portion of order 322 and information of media account 332, where order 322 is recorded in user shopping account 141 managed by third party shopping system 140. User shopping account 141 corresponds to media account 332 associated with media device 106 based on information of media account 332.

In some embodiments, third party shopping system 140 can include an inventory management 343, a user account management 344, an order management 349, among other components. Inventory management 343 can manage the inventory associated with advertised subject 115. User account management 344 can manage information related to a user, and can include various user shopping account 141. Order management 349 can manage information related to an order, such as payment status 348, or notification 346 for the order.

In some embodiments, third party shopping system 140 can receive transmitted information 341 from media server system 330, which can include at least a portion of order 322 and information of media account 332. In addition, third party shopping system 140 can validate the portion of the order, and further check, by inventory management 343, the advertised subject is in stock provided by the third party shopping system. Third party shopping system 140 can send a confirmation to media device 106 or user device 150 that order 322 is placed successfully. Alternatively, third party shopping system 140 can send an indication that the order is not placed successfully if third party shopping system 140 fails to validate at least the portion of the order by the third party shopping system, or there is no inventory available. In some embodiments, third party shopping system 140 can notify the user the order is placed successfully by an email or a text message to the user, such as sending an email notification 353 to user device 150. In some embodiments, third party shopping system 140 can notify the user, upon a failure to validate at least the portion of the order by the third party shopping system, an indication that the order is not placed successfully, which can be included in email notification 353 to user device 150.

In some embodiments, media device 106 can receive, upon a successful validation of at least the portion of order 322 by third party shopping system 140, a confirmation from third party shopping system 140 that order 322 is placed successfully. In some embodiments, media device 106 can receive the confirmation after third party shopping system has validated the portion of the order, and the advertised subject is in stock provided by the third party shopping system. Afterwards, media device 106 can notify the user the order is placed successfully by an email or a text message to the user, such as sending an email notification 353 to user device 150. In some embodiments, media device 106 can receive, upon a failure to validate at least the portion of the order by the third party shopping system, an indication that the order is not placed successfully.

In some embodiments, as shown in FIG. 4G, media device 106 can notify the user the order is placed successfully by an email notification 453. Additionally and alternatively, media device 106 can notify the user the order is placed successfully by a text message.

In some embodiments, media device 106 can facilitate a payment to media server system 330 based on the payment information 325 included in order 322 to purchase advertised subject 115. Media server system 330, e.g., content sever 120, can include a payment management 331. Since media device 106 can be uniquely identified by media account 332, there may be a long term business relationship between the user of media device 106 and media server system 330. Accordingly, the collection of payment for order 322 can be more flexible than one time transaction that occurs in a normal ecommerce website. In some embodiments, payment management 331 may collect the payment from user 132 based on payment information 325 at a time different from the time when order 322 is placed. In addition, payment may be transferred to third party shopping system 140 from media server system 330 at a different time when payment is collected by media server system 330. For example, payment may be transferred to third party shopping system 140 from media server system 330 once a month, or in other time frequency instead of transferring the payment on each order.

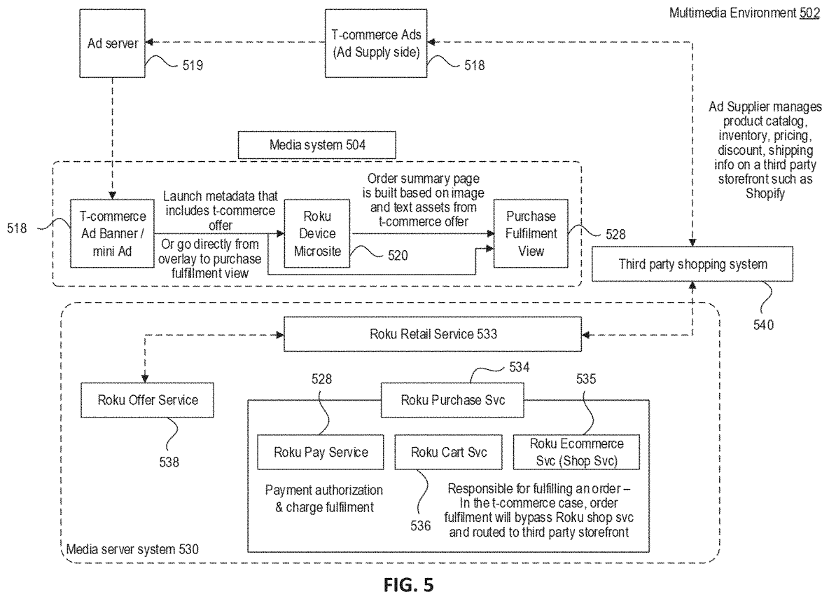

FIG. 5 illustrates an example multimedia environment 502 for controlling a computing device to place an order through a media server system for an advertised subject provided by a third party shopping system, according to some embodiments. Multimedia environment 502 can be an example of multimedia environment 102, showing different details of the multimedia environment.

In some embodiments, multimedia environment 502 includes a media system 504, a media server system 530, and a third party shopping system 540. Media system 504 may be an example of media system 104, and may include a media device similar to media device 106, and a display device similar to display device 108. Media server system 530 may include components similar to content server 120 and system server 126. Third party shopping system 540 may be an example of third party shopping system 140.

In some embodiments, third party shopping system 540 may provide T-commerce advertisement 518, which may be similar to advertisement 117. T-commerce advertisement 518 may be stored in an ad server 519. Ad server 519 can provide T-commerce advertisement 518 to media system 504 to be displayed on the display device of media system 504. In addition, media system 504 can display a microsite 520, similar to microsite 320 as described for FIG. 3. In addition, media system 504 can display purchase fulfillment view 528, which can include various information as described in FIG. 3, such as information 326 about advertised subject 115, information 324 included in an order 322, information 323 about a user, information 321 about the advertised subject, payment information 325, shipping information 327, security information 329, among other information. In some embodiments, T-commerce advertisement 518 can launch metadata that includes t-commerce offer to launch microsite 520. Order summary page is built based on image and text assets from t-commerce offers and shown in purchase fulfillment view 528. Additionally and alternatively, T-commerce advertisement 518 can directly go to fulfillment view 528.

In some embodiments, media server system 530 can be an example of media server system 330, and perform functions described in FIG. 3 for media server system 330. Besides the content service as described in FIG. 3 and provided by content server 120, media server system 330 can provide retail service 533, offer service 538, purchase service 534, payment service 531, shopping cart service 536, and ecommerce service 535. For example, payment service 531 can facilitate a payment to third party shopping system 540 from media server system 530 based on the payment information included in an order to purchase the advertised subject. In addition, media server system 530, e.g., retail service 533, can provide its own online shopping services through media system 504, in addition to offer advertised subjects from third party shopping system 540.

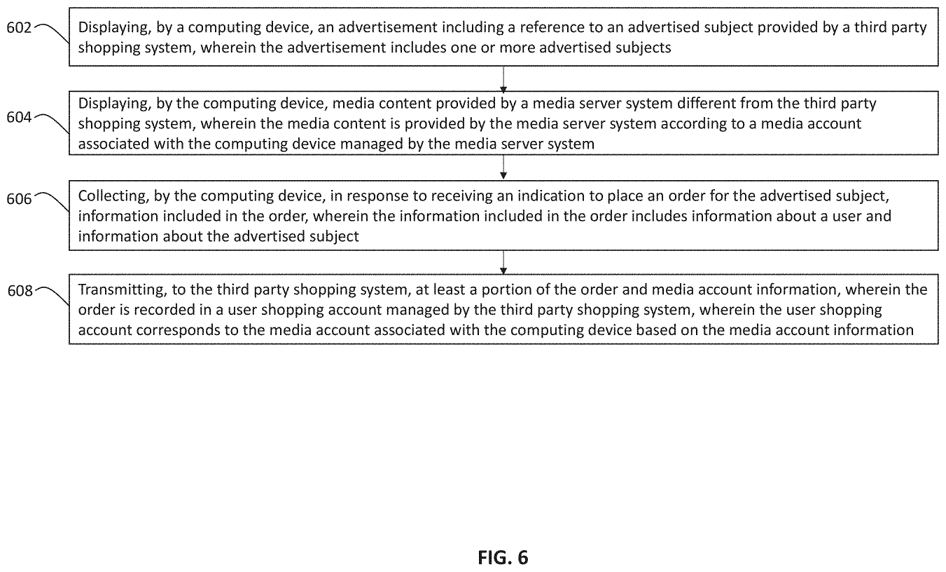

FIG. 6 illustrates an example process 600 performed by media device 106 to place an order through a media server system for an advertised subject provided by a third party shopping system, according to some embodiments. Processes 600 can be performed by processing logic that can comprise hardware (e.g., circuitry, dedicated logic, programmable logic, microcode, etc.), software (e.g., instructions executing on a processing device, such as by controller 303), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

At 602, media device 106 can display an advertisement including a reference to an advertised subject provided by a third party shopping system, where the advertisement includes one or more advertised subjects. For example, as described for FIG. 3, media device 106 can display an advertisement 117 including a reference to advertised subject 115 provided by third party shopping system 140.

At 604, media device 106 can display media content provided by a media server system different from the third party shopping system. The media content is provided by the media server system according to a media account associated with the computing device managed by the media server system. For example, as described for FIG. 3, media device 106 can display media content 113 provided by media server system 330 different from third party shopping system 140.

At 606, media device 106 can collect, in response to receiving an indication to place an order for the advertised subject, information included in the order, where the information included in the order includes information about a user and information about the advertised subject. For example, as described for FIG. 3, media device 106 can collect, in response to receiving an indication to place order 322 for advertised subject 115, information 324 included in order 322. Information 324 included in order 322 includes information 323 about a user and information 321 about the item associated with the advertised subject.

At 608, media device 106 can transmit, to the third party shopping system, at least a portion of the order and media account information. The order is recorded in a user shopping account managed by the third party shopping system, where the user shopping account corresponds to the media account associated with the computing device based on the media account information. For example, as described for FIG. 3, media device 106 can transmit, to the third party shopping system, at least a portion of the order and media account information as included in transmitted information 341. Order 322 is recorded in user shopping account 141 managed by third party shopping system 140, where user shopping account 141 corresponds to media account 332 associated with media device 106 based on the media account information.

There can be other operations performed by media device 106, which are not shown in process 600. For example, media device 106 can receive, upon a successful validation of at least the portion of the order by the third party shopping system, a confirmation from the third party shopping system that the order is placed successfully. Media device 106 can further facilitate a payment to the media server system based on the payment information included in the order to purchase the advertised subject. Media device 106 can display further information of the advertised subject for the user to select the item, wherein the information of the advertised subject includes a size of the advertised subject, a color of the advertised subject, a quantity of the item to be purchased, a functional feature of the advertised subject, or a sales promotion information.

### Example Computer System

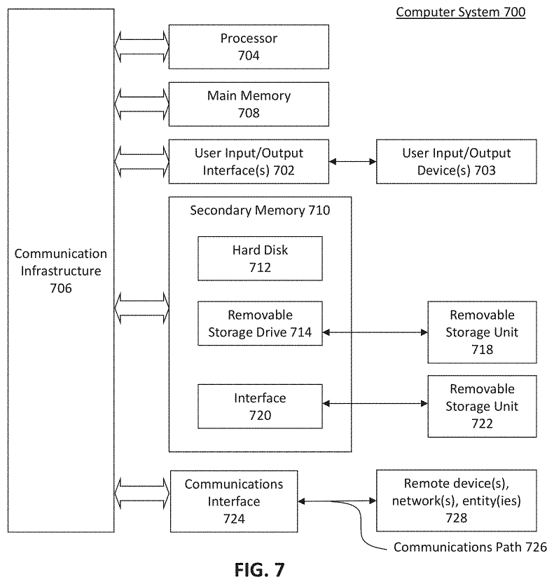

Various embodiments may be implemented, for example, using one or more well-known computer systems, such as computer system 700 shown in FIG. 7. For example, media device 106, display device 108, user device 150, third party shopping system 140, content server 120, system server 126, media system 504, media server system 530, third party shopping system 540, may be implemented using combinations or sub-combinations of computer system 700 to perform various functions described herein, e.g., by process 600. Also or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method, comprising:
displaying, by a computing device, an advertisement including a reference to an advertised subject provided by a third party shopping system;
displaying, by the computing device, media content provided by a media server system different from the third party shopping system, wherein the media content is provided by the media server system according to a media account associated with the computing device managed by the media server system;
collecting, by the computing device, in response to receiving an indication to place an order for the advertised subject, information included in the order, wherein the information included in the order includes information about a user and information about the advertised subject; and
transmitting, by the computing device to the third party shopping system, at least a portion of the order and media account information, wherein the order is recorded in a user shopping account that is managed by the third party shopping system and that corresponds to the media account that is managed by the media server system and associated with and uniquely identifying the computing device based on the media account information.

2. The method of claim 1, wherein the order is recorded in the user shopping account without a user logging in to the user shopping account in the third party shopping system.

3. The method of claim 1, further comprising:
receiving, upon a successful validation of at least the portion of the order by the third party shopping system, a confirmation from the third party shopping system that the order is placed successfully.

4. The method of claim 3, wherein the receiving the confirmation from the third party shopping system comprises receiving the confirmation after the third party shopping system has validated the portion of the order, and the advertised subject is in stock provided by the third party shopping system.

5. The method of claim 1, wherein the order further includes payment information, and the method further comprises:
facilitating a payment to the media server system based on the payment information included in the order to purchase the advertised subject.

6. The method of claim 1, wherein the information about the user includes shipping information for the user or payment information for the user.

7. The method of claim 1, further comprising:
displaying further information of the advertised subject for the user to select the item, wherein the information of the advertised subject includes a size of the advertised subject, a color of the advertised subject, a quantity of the advertised subject to be purchased, a functional feature of the advertised subject, or a sales promotion information.

8. The method of claim 1, further comprising:
notifying the user the order is placed successfully by an email or a text message to the user.

9. The method of claim 1, further comprising:
receiving, upon a failure to validate at least the portion of the order by the third party shopping system, an indication that the order is not placed successfully.

10. The method of claim 1, further comprising:
receiving user input from a remote control associated with the computing device to place the order.

11. The method of claim 1, wherein the advertisement is displayed at a same time when the media content is displayed.

12. The method of claim 1, wherein at least an item associated with the advertised subject is in stock of an inventory provided by the third party shopping system.

13. The method of claim 1, wherein the advertised subject is displayed based on a user profile or demographic information of the user.

14. The method of claim 1, wherein the order is placed in a microsite displayed by the computing device, and wherein the microsite is provided by the third party shopping system.

15. A computing device, comprising:
a storage device to store an advertisement including a reference to an advertised subject provided by a third party shopping system, wherein the advertisement includes one or more advertised subjects; and
a controller coupled to the storage device and configured to:
display, on a display device, the advertisement;
display, on the display device, media content provided by a media server system different from the third party shopping system, wherein the media content is provided by the media server system according to a media account associated with the computing device managed by the media server system;
collect, in response to receiving an indication to place an order for the advertised subject, information included in the order, wherein the information included in the order includes information about a user and information about the item associated with the advertised subject; and
transmit, to the third party shopping system, at least a portion of the order and media account information, wherein the order is recorded in a user shopping account managed by the third party shopping system, wherein the user shopping account managed by the third party shopping system corresponds to the media account that is managed by the media server system and associated with and uniquely identifying the computing device based on the media account information.

16. The computing device of claim 15, wherein the order is recorded in the user shopping account without a user logging in to the user shopping account in the third party shopping system.

17. The computing device of claim 15, wherein the controller is further configured to:
receive, upon a successful validation of at least the portion of the order by the third party shopping system, a confirmation from the third party shopping system that the order is placed successfully.

18. The computing device of claim 15, wherein the controller is further configured to:
display further information of the advertised subject for the user to select, wherein the information of the advertised subject includes a size of the advertised subject, a color of the advertised subject, a quantity of the advertised subject to be purchased, a functional feature of the advertised subject, or a sales promotion information.

19. A non-transitory computer-readable medium having instructions stored thereon that, when executed by at least a computing device, cause the computing device to perform operations comprising:
displaying, by the computing device, an advertisement including a reference to an advertised subject provided by a third party shopping system, wherein the advertisement includes one or more advertised subjects;
displaying, by the computing device, media content provided by a media server system different from the third party shopping system, wherein the media content is provided by the media server system according to a media account associated with the computing device managed by the media server system;
collecting, by the computing device, in response to receiving an indication to place an order for the advertised subject, information included in the order, wherein the information included in the order includes information about a user and information about the advertised subject; and
transmitting, to the third party shopping system, at least a portion of the order and media account information, wherein the order is recorded in a user shopping account managed by the third party shopping system, wherein the user shopping account managed by the third party shopping system corresponds to the media account that is managed by the media server system and associated with and uniquely identifying the computing device based on the media account information.

20. The non-transitory computer-readable medium of claim 19, wherein the order is recorded in the user shopping account without a user logging in to the user shopping account in the third party shopping system.
